(19) United States
(12) Patent Application Publication
(10) Pub. No.: US 2010/0257832 A1
(43) Pub. Date: Oct. 14, 2010

(54) Mower Blade

(76) Inventor: Robert L. Smith, Abilene, TX (US)

Correspondence Address: WILSON DANIEL SWAYZE, JR., 3804 CLEARWATER CT., PLANO, TX, 75025, US

(21) Appl. No.: 12/423,457

(22) Filed: Apr. 14, 2009

(51) Int. Cl. A01D 34/73

(52) U.S. Cl. 56/295

(57) ABSTRACT

A mower blade and deck assembly for a mower may include a top surface of the deck assembly includes an aperture for accessing the mower blade, and the mower blade may have a detachable cutting blade being detachably connected to the mower blade. The detachable cutting blade of the mower blade may be accessible through the aperture of the top surface of the deck assembly in order to detach and replace the detachable cutting blade. The mower blade may include a depression in order to position the detachable cutting blade, and the detachable cutting blade substantially may not extend beyond a side edge of the mower blade. The detachable cutting blade may extend beyond a side edge of the mower blade and detachable cutting blade may include a non-round aperture to cooperate with a aperture in the mower blade. The non-round aperture may be square, and the non-round aperture may be oval.

### FIELD OF THE INVENTION

The present invention relates to mowers and more particularly to an improved system for mower blade replacement.

### BACKGROUND

There is a constant effort to improve the efficiency of blades used on lawnmowers and in particular on powered lawnmowers not only for cutting grass and the like, but also for mulching purposes. U.S. Pat. No. 5,581,987 discloses a mower blade which can be utilized with both cutting and mulching mowers.

In general, a rotary lawnmower includes a mower blade mounted below the deck which rotates about an axis. The free end of the blade includes a cutting edge. The cutting edge is typically subject to wear from cutting grass and more particularly from striking objects such as rocks and pieces of metal. As a consequence, it is desirable to replace or sharpen the mower blades in order to maintain a sharp mower blade. Typically this requires turning the mower over which may result in the gasoline which is used to power the mower being spilled which may cause a hazardous situation. The mower deck is usually heavy, and it may be difficult to remove.

It would be desirable to be able to replace mower blades without turning the mower over.

### SUMMARY

A mower blade and deck assembly for a mower may include, in the top surface of the deck assembly, an aperture for accessing the mower blade, and the mower blade may have a detachable cutting blade being detachably connected to the mower blade.

The detachable cutting blade of the mower blade may be accessible through the aperture at the top surface of the deck assembly in order to detach and replace the detachable cutting blade.

The mower blade may include a depression in order to position the detachable cutting blade.

The detachable cutting blade may extend beyond a side edge of the mower blade.

The non-round aperture may be square, and the non-round aperture may be oval.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an exploded view of the mower blade of the present invention;

FIG. 2 illustrates another exploded view of the mower blade of the present invention;

FIG. 3 illustrates a top view of a mower deck of a mower of the present invention;

FIG. 4 illustrates a top view of the mower deck and mower blade of the present invention;

FIG. 5 illustrates a top view of the mower deck of a multi-blade system;

FIG. 6 illustrates a sectional view of the mower blade and detachable cutting blade of the present invention;

FIG. 7 illustrates a sectional view of the mower blade without the detachable cutting blade of the present invention.

### DETAILED DESCRIPTION

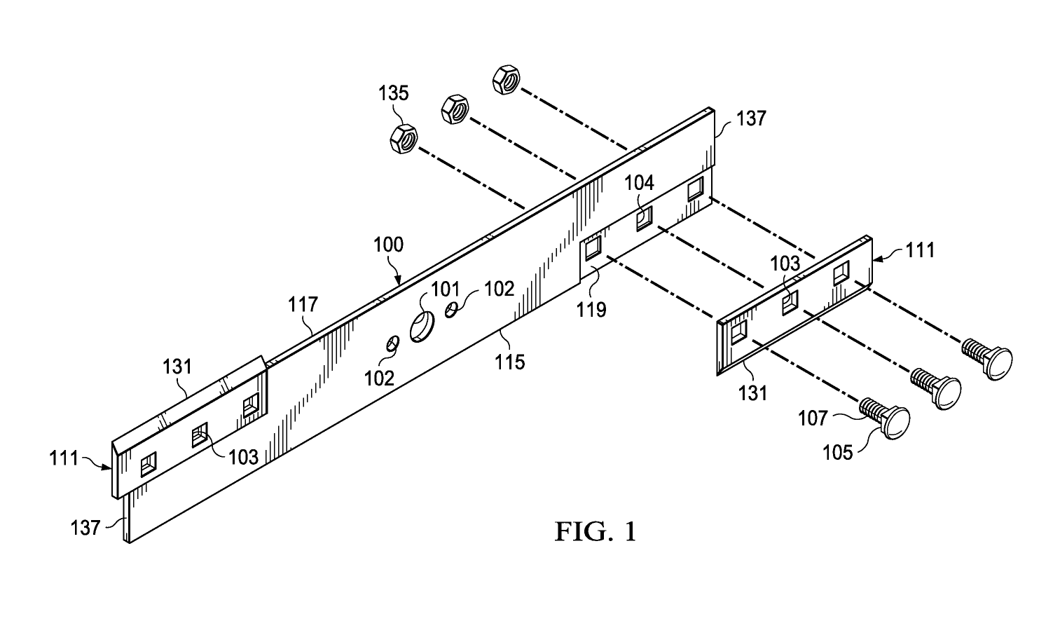

FIG. 1 illustrates the mower blade 100 which may include a central aperture 103 to connect to a shaft of a lawnmower (not shown) to rotate the mower blade 100 and may include smaller apertures 102 to lock the mower blade. FIG. 1 additionally illustrates that the mower blade 100 may include a single or multiple detachable cutting blades 111 which may be positioned on the opposing sides of the longitudinal axis of the mower blade 100. FIG. 1 illustrates that a first detachable cutting blade 111 may be positioned along the leading edge 115 of the mower blade 100 and a second detachable cutting blade 111 may be positioned along the trailing edge 117 of the mower blade 100. Both the first detachable cutting blade 111 and the second detachable cutting blade 111 may be positioned in a depression 119 which may be formed in either the top surface or the bottom surface of the mower blade 100. The first detachable cutting blade 111 and the second detachable cutting blade 111 may include a sharpened edge 131 which may extend along the longitudinal edge of the detachable cutting blade 111 to cut grass and weeds. FIG. 1 illustrates that the first detachable cutting blade 111 and the second detachable cutting blade 111 is substantially rectangular. However, other shapes for the first detachable cutting blade 111 and the second detachable cutting blade 111 such as having a curved sharpened edge 131 or shaped as a triangle, oval or other such shape are within the scope of the invention. The detachable cutting blade 111 (first or second) may include a first non-round aperture 103 to cooperate with a second non-round aperture 104 which extends through the mower blade 100. The non-round aperture may be a rectangle, square, oval or other suitable shape. The detachable cutting blade 111 may be detachably connected to the mower blade 100 by a fastening device 107 which may include a non-round shoulder 105 (shown as a substantially square) to cooperate with the first non-round aperture 103 and prevent the fastening device 107 from rotating. The fastening device 107 may be a threaded bolt or pin which may be fastened to a nut 135.

FIG. 1 illustrates that the detachable cutting blade 111 may extend beyond the side edge 137 of the mower blade 100.

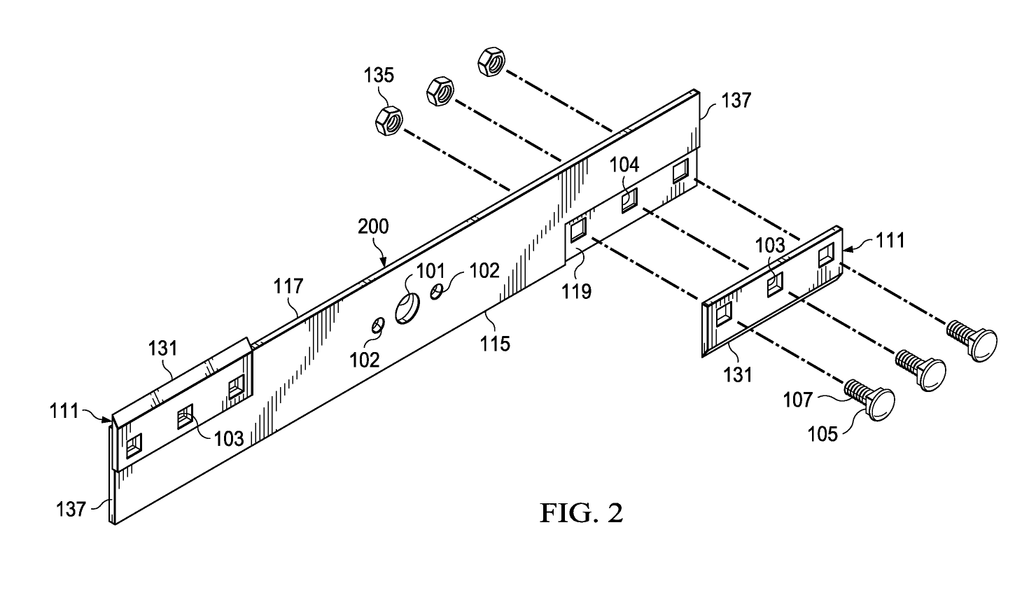

FIG. 2 illustrates the mower blade 200 which may include a central aperture 103 to connect to a shaft of a lawnmower (not shown) and may include smaller apertures 102 to lock the mower blade. FIG. 2 additionally illustrates that the mower blade 200 may include multiple detachable cutting blades 111 which may be positioned on the opposing sides of the longitudinal axis of the mower blade 200. FIG. 2 illustrates that a first detachable cutting blade 111 may be positioned along the leading edge 115 of the mower blade 200 and a second detachable cutting blade 111 may be positioned along the trailing edge 117 of the mower blade 200. Both the first detachable cutting blade 111 and the second detachable cutting blade 111 may be positioned in a depression 119 which may be formed in either the top surface or the bottom surface of the mower blade 200. The first detachable cutting blade 111 and the second detachable cutting blade 111 may include a sharpened edge 131 which may extend along the longitudinal edge of the detachable cutting blade 111 to cut grass and weeds. FIG. 2 illustrates that the first detachable cutting blade 111 and the second detachable cutting blade 111 is substantially rectangular. However, other shapes for the first detachable cutting blade 111 and the second detachable cutting blade 111 such as having a curved sharpened edge 131 or shaped as a triangle, oval or other such shape are within the scope of the invention. The detachable cutting blade 111 (first or second) may include a first non-round aperture 103 to cooperate with a second non-round aperture 104 which extends through the mower blade 200. The non-round aperture may be a rectangle, square, oval or other suitable shape. The detachable cutting blade 111 may be detachably connected to the mower blade 200 by a fastening device 107 which may include a non-round shoulder 105 (shown as a substantially square) to cooperate with the first non-round aperture 103 and prevent the fastening device 107 from rotating. The fastening device 107 may be a threaded bolt or pin which may be fastened to a nut 135.

FIG. 2 illustrates that the detachable cutting blade 111 may extend to the side edge 137 of the mower blade 200.

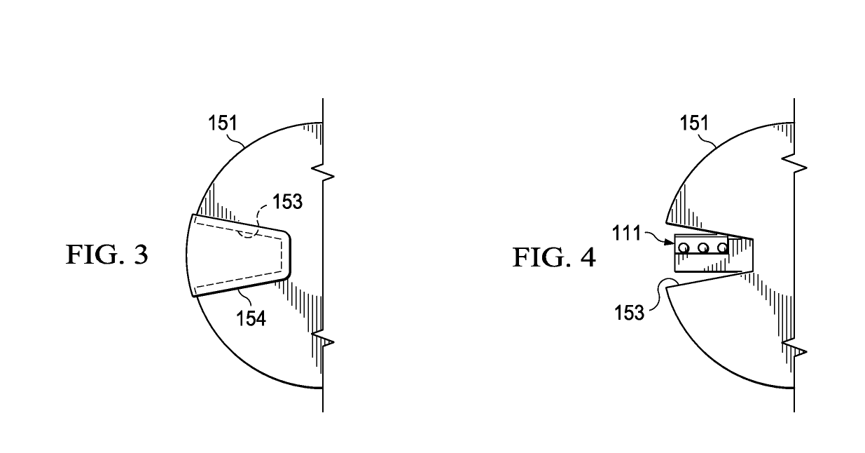

FIG. 3 illustrates a upper surface of a deck assembly 151 which may include a deck aperture 153 to allow the detachable cutting blade 111 (not shown) to be attached or removed from the mower blade 100 to allow access to the detachable cutting blade 111. The deck aperture 153 may be closed by a removable cover 154 to prevent grass and other debris from escaping the deck aperture 153. The removable cover 154 may include bolts, screws or other appropriate devices to maintain the removable cover 154 in position. The detachable cutting blade 111 can be attached or removed without removing the mower blade 100 from the mower and without the necessity of turning the deck assembly/mower over.

FIG. 4 illustrates a upper surface of a deck assembly 151 which may include a deck aperture 153 with the removable cover 154 removed to allow the detachable cutting blade 111 (shown in FIG. 4) to be attached or removed from the mower blade 100 to allow access to the detachable cutting blade 111. The detachable cutting blade 111 can be attached or removed without removing the mower blade 100 from the mower and without the necessity of turning the deck assembly/mower over.

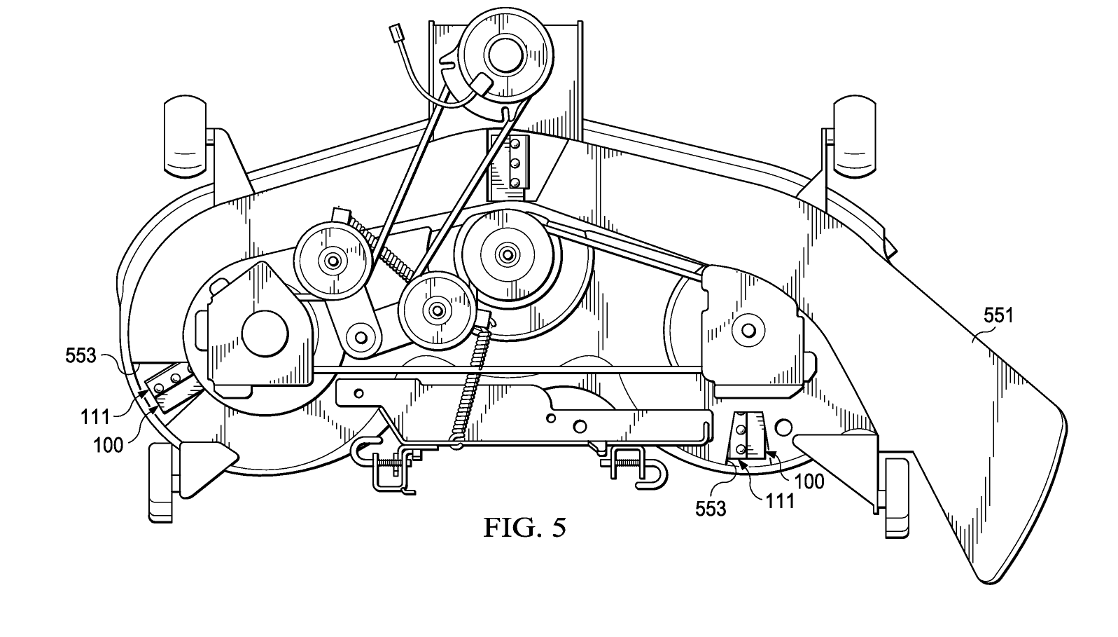

FIG. 5 illustrates a upper surface of a deck assembly 551 for multiple mower blades 100 which may be used for a riding mower or other large mower and which may include multiple deck apertures 553 to correspond to the multiple mower blades 100 and to allow the multiple detachable cutting blades 111 (shown in FIG. 4) to be attached or removed from the mower blade 100 to allow access to the detachable cutting blades 111. The detachable cutting blade 111 can be attached or removed without removing the mower blade 100 from the mower and without the necessity of turning the deck assembly/mower over.

FIG. 6 illustrates a cross-sectional view of the mower blade 100 and the detachable cutting blade 111 of the present invention. FIG. 6 illustrates the cutting edge 131 of the detachable cutting blade 111 and illustrates the leading edge 115 of the mower blade 100. The lower blade 100 may include a non-round aperture 104 to cooperate with the non-round shoulder 105 of the fastening device 107. The fastening device 107 is held in place by a nut 135. The detachable cutting blade 111 may be positioned within the depression 119.

FIG. 7 illustrates a cross-sectional view of the mower blade 100 and illustrates the leading edge 115 and the depression 119. FIG. 7 additionally illustrates the non-round aperture 104.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A mower blade and deck assembly for a mower, comprising:
a top surface of the deck assembly includes an aperture for accessing the mower blade;
a removable cover to cover the aperture for accessing the mower blade;
the mower blade having a detachable cutting blade being detachably connected to the mower blade,
wherein the detachable cutting blade of the mower blade being accessible through the aperture of the top surface of the deck assembly in order to detach and replace the detachable cutting blade.

2) A mower blade and deck assembly for a mower as in claim 1, wherein the mower blade includes a depression in order to position the detachable cutting blade.

3) A mower blade and deck assembly for a mower as in claim 1, wherein the detachable cutting blade substantially does not extend beyond a side edge of the mower blade.

4) A mower blade and deck assembly for a mower as in claim 1, wherein the detachable cutting blade extends beyond a side edge of the mower blade.

5) A mower blade and deck assembly for a mower as in claim 1, wherein the detachable cutting blade includes a non-round aperture to cooperate with a aperture in the mower blade.

6) A mower blade and deck assembly for a mower as in claim 5, wherein the non-round aperture is square.

7) A mower blade and deck assembly for a mower as in claim 5, wherein the non-round aperture is oval.
